(19) United States
(12) Patent Application Publication
(10) Pub. No.: US 2025/0011956 A1
(43) Pub. Date: Jan. 9, 2025

(54) PROCESS OF EXTRACTING NICKEL SULFATE FROM ASBESTOS MINING RESIDUE

(71) Applicant: ALLIANCE MAGNÉSIUM, Danville (CA)

(72) Inventors: Joël FOURNIER, Danville (CA); Romain BARBAROUX, Danville (CA); Réal COURCY, Danville (CA)

(21) Appl. No.: 18/706,092

(22) PCT Filed: Oct. 31, 2022
(86) PCT No.: PCT/CA2022/051605

§ 371 Date: Apr. 30, 2024

Related U.S. Application Data
(60) Provisional application No. 63/275,986, filed on Nov. 5, 2021.

(51) Int. Cl. C25C 1/02; C01F 5/34; C01G 53/00; C01G 53/10

(52) U.S. Cl. CPC C25C 1/02; C01F 5/34; C01G 53/003; C01G 53/10

(57) ABSTRACT

It is provided a process for extracting nickel sulfate from mining ores, such as serpentine, comprising the steps of conducting a magnetic separation of the mining ores producing a magnetic fraction and a non magnetic fraction; leaching the non magnetic fraction with HCl producing a slurry comprising metals chloride; filtrating the slurry producing a metals chloride liquor; purifying the metals chloride liquor producing a magnesium chloride solution; separating an iron-nickel cake from the magnesium chloride solution; leaching the cake together with the magnetic fraction producing a metallic sulfate solution; extracting nickel and cobalt from the metallic sulfate solution by a ion exchange resin extraction and stripping producing an inorganic stripped phase; submitting the inorganic stripped phase to a liquid-liquid extraction producing a nickel concentrated phase; and evaporating and drying the nickel concentrated phase to recuperate nickel sulfate.

### CROSS-REFERENCE TO RELATED APPLICATION

The present application is claiming priority from U.S. Provisional Application No. 63/275,986 filed Nov. 5, 2021, the content of which is hereby incorporated by reference in its entirety.

### TECHNICAL FIELD

It is provided a process of extracting nickel sulfate from asbestos mining residue such as serpentine.

### BACKGROUND

Lateritic nickel ores are formed by intensive tropical weathering of olivine-rich ultramafic rocks such as dunite, peridotite and komatiite and their serpentinized derivatives. Serpentinite consists largely of the magnesium silicate serpentine. Serpentine minerals have a sheet or layered structure. Chrysotile (commonly known as white asbestos) is the only asbestos mineral in the serpentine group.

Asbestos is a set of six naturally occurring silicate minerals used commercially for their desirable physical properties. They have all in common their eponymous, asbestiform habit: long and thin fibrous crystals. Asbestos became increasingly popular among manufactures and builders in the late 19^{th} century because of its sound absorption, average tensile strength, its resistance to fire, heat, electrical and chemical damage. The production has been stopped after the discovery of health problem associated to the human exposure to asbestos fiber.

The exploitation of important deposits of serpentine for the asbestos fiber in the last decades generated huge quantities of tailings. This ore consist of more than 90% serpentine (also known as magnesium iron silicate hydroxide), mainly as lizardite Mg₃Si₂O₅(OH)₄ with minor antigorite (Mg, Fe)₃Si₂O₅(OH)₄, brucite Mg(OH)₂, magnetite Fe₃O₄, awarite Ni₈Fe₃, traces of chromite Fe(Cr, Fe)₂O₄ and chromium-rich spinel (Cr, Fe, Al, Mg)₃O₄.

From a chemistry point of view, asbestos mine tailings contain between 23-27% of magnesium, around 38% SiO₂, 1-6% Fe, 0.2-0.3% Al and 0.1-0.3% Ni. Trace amounts of others significant elements like Co are also present.

Several hydrometallurgical processes were developed for asbestos tailing treatment. Production of magnesium and bi-product has been shown in U.S. Pat. No. 10,563,314, which is incorporated herewith in its entirety. The process described a new way for magnesium production and included a bearing ore leaching with HCl resulting in dissolution of the metal contained.

MgO+2HCl=MgCl₂+H₂O

FeO+2HCl=FeCl₂+H₂O

Fe₂O₃+6HCl=2FeCl₃+3H₂O

NiO+2HCl=NiCl₂+H₂O

CoO+2HCl=COCl₂+H₂O

The silica remain undissolved and due to its amorphous properties can be used into various application such as concrete formulation (see WO2021179067) and tire industries.

There is a need to be provided with a mean of using asbestos mining residue as a source of nickel sulfate.

The main source of nickel mined come from two type of ore deposit:
1—laterites where the principal ore minerals are nickeliferous limonite [(Fe,Ni)O(OH)] and garnierite (a hydrous nickel silicate), or
2—magmatic sulfide deposits where the principal ore mineral is pentlandite [(Ni,Fe)₉S₈].

Nickel is facing a significant increase in demand due to the development of batteries for transportation electrification. Nickel laterites are a very important type of nickel ore deposit. They are growing to become the most important source of nickel metal for world demand (currently second to sulfide nickel ore deposits).

Typical nickel laterite mine often operates as either an open cut mine or a strip mine. It required to move a large quantity of ore and generate important environmental challenges. Nickel is extracted from the ore by a variety of process routes. Hydrometallurgical processes include high-pressure acid leach (HPAL). Another hydrometallurgical routes is the Caron process, which consists of roasting followed by ammonia leaching and precipitation as nickel carbonate. The main disadvantages of the HPAL are the energy required and technical risk to heat the ore material and acid, and the wear and tear hot acid causes upon plant and equipment. Higher energy costs demand higher ore grades. The Caron Process is also presenting significant risk in regard of the ammonia leaching.

The ionic radius of divalent nickel is close to that of divalent iron and magnesium, allowing the three elements to substitute for one another in simple extraction chemicals process.

It is thus highly desired to be provided with a mean of extracting nickel sulfate from asbestos mining residue.

### SUMMARY

It is provided a process for extracting nickel sulfate from mining ores comprising the steps of providing mining ores containing nickel; conducting a magnetic separation of the mining ores producing a magnetic fraction and a non magnetic fraction; leaching the non magnetic fraction with HCl producing a slurry comprising metals chloride; filtrating the slurry producing a metals chloride liquor; purifying the metals chloride liquor producing a magnesium chloride solution; separating an iron-nickel cake from the magnesium chloride solution; leaching the cake together with the magnetic fraction producing a metallic sulfate solution; extracting nickel and cobalt from the metallic sulfate solution by a ion exchange resin extraction and stripping producing an inorganic stripped phase; submitting the inorganic stripped phase to a liquid-liquid extraction producing a nickel concentrated phase; and evaporating and drying the nickel concentrated phase to recuperate nickel sulfate.

In an embodiment, the process encompassed herein further comprises a step of grinding the provided mining ores.

In another embodiment, the mining ores are from asbestos tailing.

In a further embodiment, the metals chloride liquor is purified by increasing the pH.

In another embodiment, the pH is increased by adding magnesium oxide and an oxidizing agent.

In a supplemental embodiment, the metals chloride liquor is purified by precipitation at pH 5.

In a further embodiment, the cake together and the magnetic fraction are leached with H₂SO₄.

In an embodiment, the metallic sulfate solution is further filtrated and neutralized.

In another embodiment, the metallic sulfate solution is neutralized with a neutralizing agent and oxidizing agent.

In a further embodiment, the neutralizing agent is calcium oxide.

In an embodiment, the metallic sulfate solution pH is increased to precipitate residual metallic impurities.

In a further embodiment, residual metallic impurities are Fe₂O₃, Al, Cr, Si, Mn, Ca, or a combination thereof.

In an embodiment, the process encompassed herein further comprises a step of filtrating the neutralized metallic sulfate solution separating a first portion of metal impurities.

In an embodiment, the ion exchange extraction phase is performed using a Downex M4195 resin.

In a further embodiment, cobalt is extracted during the liquid-liquid extraction.

In an embodiment, the process encompassed herein further comprises the step of evaporating the magnesium chloride solution providing a MgCl₂ solution.

In an embodiment, the process encompassed herein further comprises spray roasting the MgCl₂ solution to obtain an MgO and liberate HCl gas which is recycled to the leaching step c).

In another embodiment, MgCl₂·6H₂O is recovered by crystallization of the MgCl₂ solution.

In an embodiment, the MgCl₂·6H₂O is further dehydrated to obtain anhydrous magnesium chloride.

In an embodiment, the process encompassed herein further comprises electrolysing the anhydrous magnesium chloride to recover magnesium metal.

### BRIEF DESCRIPTION OF THE DRAWINGS

Reference will now be made to the accompanying drawings.

FIG. 1 illustrates a bloc diagram of a process according to on embodiment for producing nickel sulfate.

### DETAILED DESCRIPTION

In accordance with the present disclosure there is now provided a process for asbestos tailling remediation by producing various product including nickel sulfate, amorphous silica, magnesium metal, synthetic magnesium oxide and cobalt carbonate.

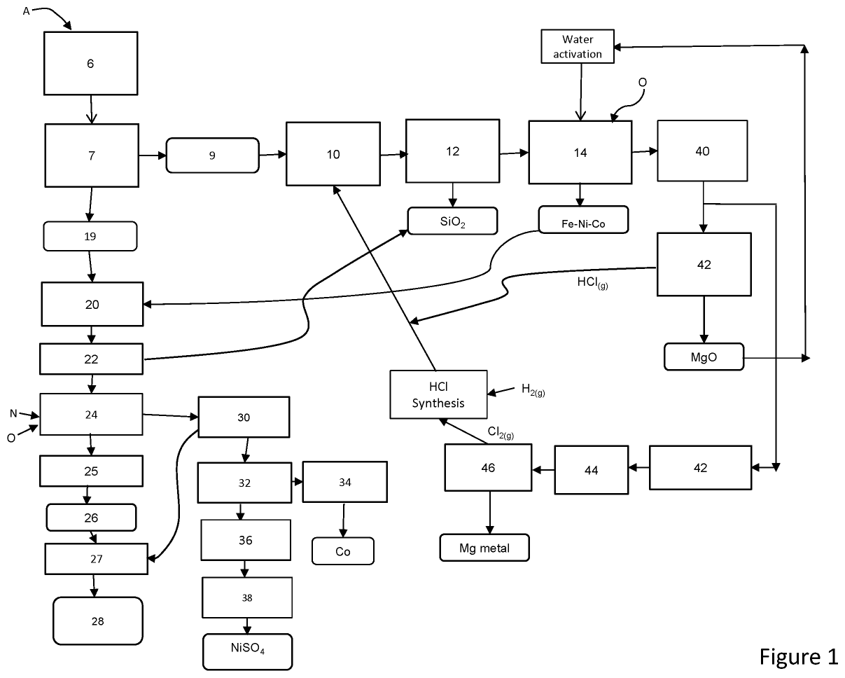

As illustrated in FIG. 1, the process comprises firstly the step of leaching 10 the non magnetic fraction 9 of nickel containing ores A with dilute HCl obtaining a slurry comprising metals chloride.

In an embodiment, the non magnetic fraction 9 is the result of grinding 6 and subsequent magnetic separation 7 of nickel containing ores such as serpentine.

The slurry is filtrated 12 to obtain a metals chloride liquor and a silica by-product. The metals chloride liquor is purified 14 by increasing the pH by adding magnesium oxyde and an oxidyzing agent O producing a magnesium chloride solution. In an embodiment, the purification is accomplished by precipitation at pH 5.

Subsequently, iron, nickel residues (forming a iron nickel cake) are separated from the magnesium chloride solution.

As disclosed in table 1, the composition of the iron nickel cake shows a high presence of iron and magnesium, in addition to nickel, cobalt and silica.

TABLE 1
Iron-nickel-cobalt cake content

| Ele- | Concentration | Concen- | Ele- | Concentration | Concen- |
|---|---|---|---|---|---|
| ments | mg/100 g | tration % | ments | mg/100 g | tration % |
| Ag | LD | — | Na | LD | — |
| Al | 3856 | 3.9 | Ni | 1587 | 1.6 |
| As | LD | — | P | 86.5 | 0.1 |
| Ba | 5.1 | 0.0 | Pb | 19.2 | 0.0 |
| Be | 0.1 | 0.0 | Sb | LD | — |
| Bi | LD | — | Se | LD | — |
| Ca | 53 | 0.1 | Sn | LD | — |
| Cd | LD | — | Sr | 0.2 | 0.0 |
| Co | 64 | 0.1 | Ti | 31.1 | 0.0 |
| Cr | 704 | 0.7 | Tl | LD | — |
| Cu | 3.8 | 0.0 | U | LD | — |
| Fe | 33558 | 33.6 | V | 19.2 | 0.0 |
| K | LD | — | W | LD | — |
| Li | LD | — | Y | 1.1 | 0.0 |
| Mg | 8702 | 8.7 | Zn | 12.5 | 0.0 |
| Mn | 102 | 0.1 | B | 9.6 | 0.0 |
| Mo | LD | — | Si | 1654 | 1.7 |

LD: limit of detection

The iron present in the cake are leached 20 together with the magnetic fraction 19 of serpentine using H₂SO₄.

After filtration 22 following the leaching step 20, a neutralizing agent N and an oxidizing agent O are added (e.g. calcium oxide or “lime”) for neutralisation 24 and the pH of the metallics sulfate solution is increased to precipitate residual metallic impurities 28 by sulfation (e.g. Fe₂O₃, Al, Cr, Si, Mn, Ca). Chromium sulfation follows the equation:

CrO+H₂SO₄=CrSO₄+H₂O

In an embodiment, after neturalisation 24, a filtration 25 is conducted separating a first portion of metal impurities 26 (Fe₂O₃, Al, Cr, Si) following a final neutralisaiton 27 to obtain maximum recovery of residual metallic impurities 28.

After neutralisation 24, nickel and cobalt are extracted by a ion exchange resin extraction step 30 using e.g. a Downex resin (e.g. DOWEX™ M4195 Chelating resin for copper, nickel, and cobalt). The magnesium sulfate solution remains in the leachate and is returned to the final neutralisation step 27.

After stripping of the resin M4195 loaded with Ni and Co, the elution solution loaded with Ni and Co is treated 32 by a liquid/liquid extraction with an organic solution Cyanex 272 1M at pH 6-6.5. Cobalt and other impurities are extracted 34 with the organic solution.

The residual aqueous solution then contains only Ni. The latter can, for high purity reasons, be extracted in turn, selectively by C272 1M to then produce a solution of high purity Ni sulfate.

Nickel is recuperated following evaporation 36 and cristallisation phase 38 by cooling of the nickel concentrated phase to obtain a nickel sulfate.

### Nickel Recovery

After the purification and separation steps, nickel in chloride solution can also be precipitated as an hydroxide by increasing the pH with a base, such as magnesium oxide, sodium hydroxide, potassium hydroxide or a mixture thereof, until pH 6-7. The nickel precipitation step is made at 80° C. The metal is then recovered by filtration.

Alternately, the magnesium chloride solution can pass a set of ion exchange resin beds comprising a chelating resin system to catch specifically the nickel. For example, the DOWEX™ M4195 resin can be used for recovering nickel from acidic brine solution. In U.S. Pat. No. 5,571,308, the use of a selective resin to remove the nickel from a leach liquor is described. The absorbed element is furthermore recovered from the ion exchange resin by contacting this one with a mineral acid whish eluted the nickel.

Nickel oxide (NiO) or nickel (Ni) can be obtained by pyro-hydrolysis or electrowining of the nickel solution.

As provided herein, the nickel sulfate is extrated in a global process of valorisation of asbestos tailling. Following the purification step 14 by increasing the pH to produce the magnesium chloride solution, the magnesium brine is evaporated 40 providing a MgCl₂ solution and subsequently the MgCl₂ solution is spray roasted 42 to obtain an MgO and liberate HCl gas that can be returned to the HCl leaching step 10. MgCl₂·6H₂O is recovered by crystallization 42 of a part of the brine. The recovered MgCl₂·6H₂O is dehydrated 44 to obtain anhydrous magnesium chloride using dry gaseous hydrogen chloride. The anhydrous magnesium chloride is electrolyze 46 in an electrolytic cell fed, containing an anode and a cathode, wherein magnesium metal is recovered.

### Example I

### Leaching

To confirm the extraction of magnesium and nickel, magnetic fraction of serpentine tailing presented in Table 2 was leached under the conditions presented below. At the end of this step, the slurries were filtered and the leachates analyzed to know the yield of extraction of several elements. The experiments were realized in an apparatus under reflux and agitation. Magnesium extraction was beyond 90% and around 100% for nickel.

TABLE 2
Yield of soluble elements extraction

| | Leaching 1 | Leaching 2 | Leaching 3 |
|---|---|---|---|
| | Conditions | Conditions | Conditions |
| | 300 g magnetic | 150 g magnetic | 200 g |
| | 1200 + 17000 | 1200 + 17000 | magnetic |
| | proportion 50:50 | proportion 50:50 | 1200 |
| | HCl 7M | HCl 7M | HCl 7M |
| | Stochiometry | Stochiometry | Stochiometry |
| | 1.05 | 1.05 | 1.05 |
| | 90 minutes | 120 minutes | 120 minutes |
| | 85-90° C. | 85-90° C. | 80-85° C. |
| | Yield of | Yield of | Yield of |
| | extraction | extraction | extraction |
| Elements | % | % | % |
| Al | 57 | 58 | 54 |
| Cr | 18 | 24 | 24 |
| Co | 60 | 67 | 87 |
| Ca | 22 | 27 | 34 |
| Fe | 96 | 98 | 118 |
| Mg | 93 | 92 | 113 |
| Mn | 70 | 74 | 84 |
| Ni | 114 | 98 | 116 |
| K | 63 | 50 | 50 |
| Ti | 23 | 35 | 37 |
| Silica residu | 169 g | 76 g | 79 g |

Table 3 shows the chemical composition on oxide base and the specific surface area of no dissolved portion from leaching 2 described in Table 1. The high SiO₂ content combined with the amorphous characteristic demonstrate a great application potential in various industrial sectors.

TABLE 3
Chemical composition of silica fraction from leaching 2

| SiO2 | Al2O3 | Fe2O3 | MgO | CaO | Na2O | K2O | TiO2 | P2O5 | Mn3O4 | Cr2O3 | NiO | LOI | Sum |
|---|---|---|---|---|---|---|---|---|---|---|---|---|---|
| 88.3% | 1.1% | 2.0% | 4.6% | 1.0% | 0.1% | 0.1% | 0.1% | 0.0% | 0.1% | 1.1% | 0.0% | 1.0% | 99.5% |

BET: 390 000 m²/g

While the present disclosure has been described in connection with specific embodiments thereof, it will be understood that it is capable of further modifications and this application is intended to cover any variations, uses, or adaptations including such departures from the present disclosure as come within known or customary practice within the art to and as may be applied to the essential features hereinbefore set forth, and as follows in the scope of the appended claims.

1. A process for extracting nickel sulfate from mining ores comprising the steps of:
a) providing mining ores containing nickel and magnesium;
b) conducting a magnetic separation of the mining ores producing a magnetic fraction and a non magnetic fraction;
c) leaching the non magnetic fraction with HCl producing a slurry comprising metals chloride;
d) filtrating the slurry producing a metals chloride liquor;
e) purifying the metals chloride liquor producing a magnesium chloride solution;
f) separating an iron-nickel cake from the magnesium chloride solution by leaching the cake together with the magnetic fraction producing a metallic sulfate solution;
g) extracting nickel and cobalt from the metallic sulfate solution by a ion exchange resin extraction and stripping producing an inorganic stripped phase;
h) submitting the inorganic stripped phase to a liquid-liquid extraction producing a nickel concentrated phase; and
i) evaporating and drying the nickel concentrated phase to recuperate nickel sulfate.

2: The process if claim 1, further comprising a step of grinding the provided mining ores.

3: The process of any one of claim 1, wherein the mining ores are from asbestos tailing.

4: The process of claim 3, wherein the mining ores are serpentine.

5: The process of claim 1, wherein the metals chloride liquor is purified by increasing the pH.

6: The process of claim 5, wherein the pH is increased by adding magnesium oxide and an oxidizing agent.

7: The process of claim 1, wherein the metals chloride liquor is purified by precipitation at pH 5.

8: The process of claim 1, wherein the cake together and the magnetic fraction are leached with H₂SO₄.

9: The process of claim 1, wherein the metallic sulfate solution is further filtrated and neutralized.

10: The process of claim 9, wherein the metallic sulfate solution is neutralized with a neutralizing agent and oxidizing agent.

11: The process of claim 10, wherein the neutralizing agent is calcium oxide.

12: The process of claim 9, wherein the metallic sulfate solution pH is increased to precipitate residual metallic impurities.

13: The process of claim 12, wherein said residual metallic impurities are Fe₂O₃, Al, Cr, Si, Mn, Ca, or a combination thereof.

14: The process of claim 10, further comprising the step of filtrating the neutralized metallic sulfate solution separating a first portion of metal impurities.

15: The process of claim 1, wherein cobalt is extracted during the liquid-liquid extraction.

16: The process of claim 1, further comprising the step of evaporating the magnesium chloride solution providing a MgCl₂ solution.

17: The process of claim 16, further comprising spray roasting the MgCl₂ solution to obtain an MgO and liberate HCl gas which is recycled to the leaching step c).

18: The process of claim 16, wherein MgCl₂·6H₂O is recovered by crystallization of the MgCl₂ solution.

19: The process of claim 18, wherein the MgCl₂·6H₂O is further dehydrated to obtain anhydrous magnesium chloride.

20: The process of claim 19, further comprising electrolysing the anhydrous magnesium chloride to recover magnesium metal.
